(19) United States
(12) Patent Application Publication
(10) Pub. No.: US 2026/0221659 A1
(43) Pub. Date: Jul. 30, 2026

(54) An Antenna

(71) Applicant: Leonardo UK Ltd, London (GB)

(72) Inventor: James DALLEY, London (GB)

(73) Assignee: Leonardo UK Ltd, London (GB)

(21) Appl. No.: 19/145,324

(22) PCT Filed: Jan. 2, 2024
(86) PCT No.: PCT/EP2024/050025

§ 371 Date: Jul. 2, 2025

(30) Foreign Application Priority Data
Jan. 3, 2023 (GB) 2300022.7

(51) Int. Cl. H01Q 11/10

(52) U.S. Cl. CPC H01Q 11/10

(57) ABSTRACT

Sinuous and log-periodic antennas are wideband frequency independent antennas which provide a similar beam width at all frequencies of operation. They can have improved directivity characteristics when formed over a conical or similar surface. Fabrication of these three-dimensional antenna structures is difficult. Exemplary embodiments disclosed herein include a dielectric sheet formed as a single integral piece that defines a central common region and radially extending arms. The flexible dielectric sheet carries a metallic patterned layer that defines, on each arm, a conductive antenna element each fed by a conductive trace provided by a portion of the metallic pattern layer formed on the common region. Each arm can be bent at its join (e.g., joint) with the common region to conform with the shape of the former without affecting the alignment between the arms.

Sinuous and log-periodic antennas are wideband frequency independent antennas which advantageously provide a similar beam width at all frequencies of operation.

They can be planar but have improved directivity characteristics when formed over a conical or similar surface, for example as disclosed in U.S. Pat. No. 4,658,262.

Fabrication of these three-dimensional antenna structures is difficult. Typically, an antenna laminate is wrapped around a frustoconical former. Any alignment error can result in a significant reduction in the high frequency performance of the antenna. Additionally, the wrap around technique is limited to frustoconical and frustopyramidal shaped formers.

The invention was conceived to ameliorate these problems and enable manufacture of antennas to accurately conform to more complex curved surfaces such as ogives for aerodynamic applications.

RU2663264 relates to a log periodic antenna comprise two identical flat metal log-period structure arranged at an angle to each other. Both logoperiodic structures are made in the form of a printed circuit board on one side of bent metal free flexible foil dielectric plate. The logperiodic structures are excited in antiphase located along the antenna axis by a power line, made in the form of an ultra-wideband symmetric matching transformer.

According to a first aspect of the invention there is provided a sinuous and/or log-periodic antenna comprising a relatively flexible dielectric substrate carrying multiple conductive antenna elements; wherein the dielectric substrate defines a common region and arms and each arm is separately joined to the common region about a separate join; each arm provides a first curved surface carrying one of the multiple conductive antenna elements; the common region provides a first planar surface carrying conductive traces for connecting each conductive antenna element to a transmission line. The flexible dielectric substrate may be carried on a relatively rigid former. The dielectric substrate may comprise a single integral piece defining the common region and arms. The single integral piece may carry a patterned metallic layer providing the multiple conductive antenna elements and the conductive traces

The common region of the dielectric substrate ensures the angular separation and spacing, (e.g. angular spacing) between antenna elements at the central high frequency region is not compromised when the substrate is mounted onto the former. Favourably the common region is comprised from a single integral continuous piece of the dielectric substrate.

Through provision of a single integral piece providing the arms and the common region a patterned metal layer providing both the conductive elements and traces can be formed by a single pattern forming process. As the patterned metal layer can define that each trace is electrically connected to it's respective conductive element, the need for soldering or a like process to electrically connect the conductive elements to the traces can be avoided.

The separate arms ameliorate the problem of conforming the antenna arms to a curved 3D surface as they allow for independent localised bending of substrate in a manner that is not possible for a rectangular or triangular shaped sheet material arranged to cover the whole former.

The first curved surface may be an ogive surface or a quadric surface, e.g. a conical, hemispherical, ellipsoidal, paraboloidal or a hybrid or truncated form of one or more of these. The former, where present, may define a second curved surface having a curvature that is substantially the same as the first curved surface. The dielectric substrate may lie over and conform to the second curved surface. The former may comprise a planar surface that supports the common region of the dielectric substrate.

To improve the arms' ability to conform to latitudinal curvature, each arm is formed to be relatively narrow proximate its join with the common region and increase in physical width with increasing distance away from its join. The change in physical width may be such that each arm has a substantially constant angular width about its length.

To further improve the arm's ability to conform to latitudinal curvature, each arm may have a profile defining curves and/or features that conform with curves and/or features of the profile of the conductive element it is carrying. For example, with an antenna having meandering conductive antenna elements, each arm may have a profile that is curved to mimic the meandering shape of the antenna element which it carries. For example, the profile of the arm may be similar (in the Euclidean geometry sense) or geometrically congruent with the profile of the antenna element that it carries

For example, for a sinusoidal antenna having sinuous conductive antenna elements, the arms may also have a sinusoidal profile. Surprisingly, the arms of a sinuous antenna can conform extremely well to a surface curved about two orthogonal planes notwithstanding being relatively wide.

The common region of the dielectric substrate may comprise an aperture for a transmission line to pass for connection to one or more of the conductive antenna elements. As such the common region may be comprised from a single integral annular piece of dielectric substrate.

To improve conformality of the dielectric substrate over the former around a region where the planer surface and second surfaced surface of the former join, the former may define a bridging surface interconnecting the second planar surface and the second curved surface. The bridging surface is favourably curved with a radius of curvature that is less than the radius of curvature of the second curved surface. Preferably the bridging surface has a radius of curvature that decreases between the second curved surface and the planar surface. The bridging surface may extend circumferentially entirely around the common region.

The antenna may be a sinuous log-periodic antenna. The antenna may be a sinuous non-log-periodic antenna. The antenna may be a non-sinuous log-periodic antenna.

The antenna may comprise four or more arms.

According to a second aspect of the invention there is provided a flexible dielectric substrate carrying conductive antenna elements of the sinuous and/or log-periodic antenna of any previous claim, wherein the flexible dielectric substrate defines a common region and separate arms, each of the separate arms being joined to the common region; and each arm carrying one of the conductive antenna elements.

According to third aspect of the invention there is provided a method of manufacturing a sinuous and/or log-periodic antenna, the method comprising:
providing flexible dielectric substrate carrying conductive antenna elements of the sinuous and/or log-periodic antenna of any previous claim wherein the flexible dielectric substrate defines a common region and separate arms, each of the separate arms being joined to the common region; and each arm carrying one of the conductive antenna elements; the common region carrying conductive traces for electrically connecting each conductive antenna element to a transmission line
placing the dielectric substrate on or in a former such that the conductive antenna elements follow a curved surface provided by the former.

The invention will now be described by way of example with reference to the following figures in which:

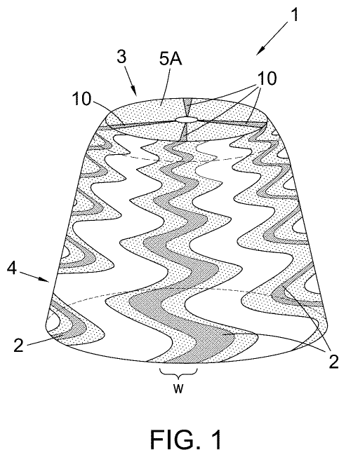

FIG. 1 a perspective view of a sinuous broadband antenna;

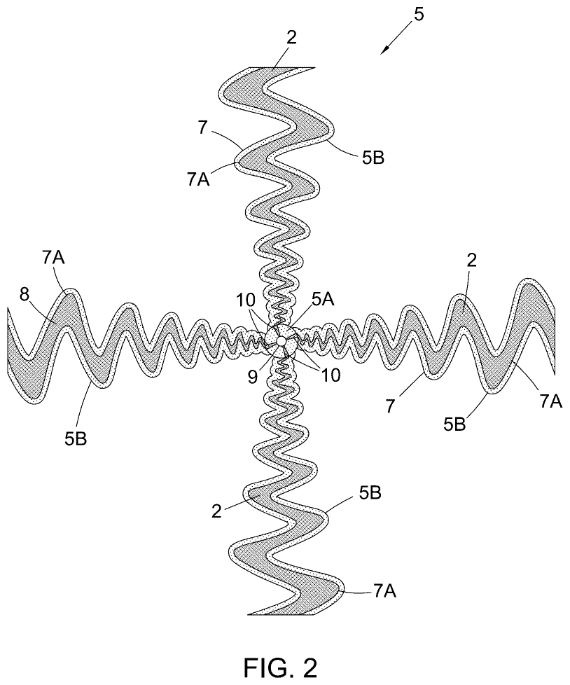

FIG. 2 is a plan view of the antenna laminate;

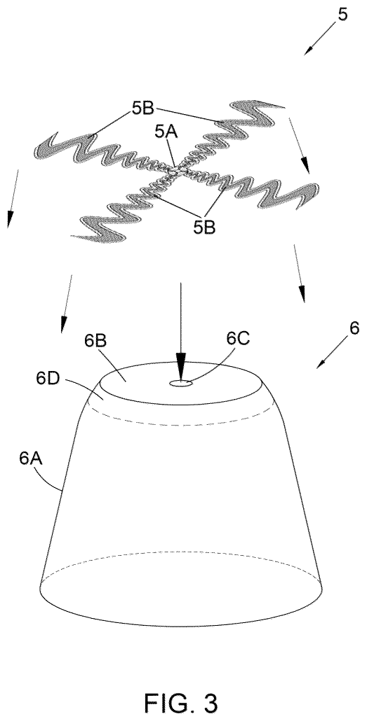

FIG. 3 is a perspective view of the antenna laminate prior to being wrapped on the former; and

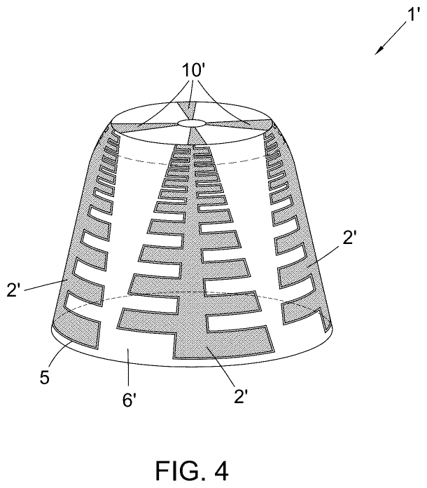

FIG. 4 is a perspective view of a log-periodic broadband antenna.

With reference to FIG. 1 there is shown a sinuous broadband antenna 1. The antenna 1 comprises multiple, in this example four, sinuous conductive elements 2 that each extend radially outwards from a planar central region 3 across a curved surface 4. The curved surface 4 may, for example, be a quadric surface or an ogive.

Each conductive element 2 is fed by a transmission line (not shown) that provides a controlled phase difference between one or more of the conductive elements 2. The conductive elements 2 may be paired such that one is fed in antiphase to the other.

Each conductive element 2 is formed to take a sinuous path across the curved surface 4 with a half wavelength that increases according to a logarithmic function with increasing radial distance from the central region 3. This feature provides the antenna 1 with frequency independent performance. The angular width W of each conductive element 2 is substantially constant about its radial distance from the central region 3. As such, the physical width of each conductive element 2 increases progressively with increased radial distance from the central region 3. Alternatively, in a variant embodiment, the angular width W may vary to improve antenna performance as discussed in U.S. Pat. No. 4,658,262.

With reference to FIGS. 2 and 3, the antenna 1 is comprised from an antenna laminate sheet 5 carried on a former 6.

The antenna laminate sheet 5 comprises a single integral piece flexible dielectric substrate 7 carrying a patterned metallic layer 8, e.g. of copper, defining the conductive elements 2 as well as feed lines 10. An example of a suitable material for the flexible dielectric substrate 7 is polyimide such as sold under the trade name Kapton®.

With reference to FIG. 2, the antenna laminate sheet 5 defines a common region 5A and separate arms 5B that each extend radially away from the common region 5A in different directions. Each arm 5B is separately joined to the common region 5A at positions circumferentially spaced apart about the common region 3A from the others. In other words each join is angularly separated from the others around the common region 3A.

Each arm 5B carries a portion of the patterned metallic layer 8 defining one of the conductive elements 2. To provide the greatest degree of flexibility, each arm 5B has a profile that is geometrically similar to the profile of the conductive trace 2, namely that it is congruent to a uniform scaling of the profile of the conductive trace 2. This arrangement gives rise to a border 7A of exposed substrate 7 of uniform width around the conductive element 2. In a variant, the substrate 7 may have a profile that is congruent with the profile of the conductive element 2, however, fabrication of such a design may be difficult because machining right to or through the metal layer can tear or rip it.

The common region 5A is comprised from an unbroken annulus of substrate 7 with a central aperture 9. The common region 5A carries the feed lines 10 that connect the antenna elements 2 to the transmission line(s) (not shown). Each feed line 10 extends across the common region 5A between the radially inward end of its respective antenna element 2 towards the aperture 9 for connection to a transmission line (not shown).

With reference to FIG. 3, the former 6 defines a curved outer surface 6A that extends circumferentially around a circular planar face 6B, the planar face 6B being substantially equal in size to the common region 5A. A hole 6C in the planar face 6B entirely through the former 6 to provide a passageway for the transmission line through the former 6.

The former 6 has sufficient rigidity to carry the antenna laminate sheet 5 without deformation of its curved outer surface 6A or planar face 6B. A suitable material for the former is polystyrene. Polystyrene's light weight is advantageous where the antenna is to be used on an aerial platform.

Extending circumferentially around the entirety of the planar end face 6B is a bridging surface 6D that conjoins the curved outer surface 6A to the end face 6B. The purpose of the bridging surface 6D is to provide a smooth transition in gradient between the curved surface 6A and end face 6B to aid conformation of the antenna laminate sheet 5 over the former 6. The bridging surface 6D may have a single radius of curvature with distance from the planar end face 6B but is preferred to have a radius of curvature that decreases as the surface extends radially inwards towards the planar end face 6B as this provides the smoothest transition in gradient between the planar end face 6B 5 and curved surface 6A.

To assemble the antenna 1, the common region 5A of the laminate sheet 5 is aligned with and is seated onto the end face 6B of the former 6. Each of the arms 5B are then folded (as illustrated by arrows) in FIG. 3 over the curved surface 6A of the former 6. The laminate sheet 5 is retained to the former 6 using a suitable adhesive. Each arm's 5B separate, relatively narrow, connection to the common region 5A allows adjacent arms 5B to bend independently about the curved surface 6A in different planes to one another allowing each arm 5B to conform to the surface 6A notwithstanding that the arms 5B are circumferentially spaced around the end face 6B.

Additionally, because each arm 5B is joined to the common region 5A, and thus to one another, through the unbroken flexible substrate sheet 7, the angular separation between each connective element 2 at the region around the join is maintained when the antenna laminar sheet 5 is mounted to the former 6. This ensures the desired antenna performance at higher operational frequencies are achievable.

The transmission lines (not shown) e.g. implemented using separate co-axial cables, are inserted through the former 6 so their ends protrude through the aligned apertures 6C, 9 of the former 6 and antenna laminate 5. The end of each transmission line is soldered or otherwise bonded to the feed lines 10 to electrically connect the transmission lines to the antenna elements 2.

Note that the antenna of FIGS. 1-3 is technically a sinuous log-periodic antenna, i.e. the manner in which the oscillations vary along its length is derived by a log function. However, it is commonly referred simply as a ‘sinuous’ antenna to distinguish it from the style of antenna illustrated in FIG. 4, described below.

FIG. 4 illustrates a variant antenna 1′ which is identical to that of FIGS. 1-3 except that the conductive elements 2′ of the antenna laminate sheet 5′ have a non-sinuous log-periodic form, common referred simply as log-periodic.

Variants to the above designs are possible. Examples are provided below.

The common region may be non-circular in shape.

Instead of a single central aperture, the common region may comprise multiple separate apertures through which different transmission lines extend.

The common region may comprise vias that provide electrical connection between the feed line on a first side of the laminate sheet to electrical contacts on an opposite facing side of the laminate sheet for connection to the transmission lines.

Similarly, the end face of the former may comprise separate apertures for separate transmission lines.

The former may be hollow. Where so, the laminate sheet may be mounted to an inner face of the former that provides the curved surface.

The antenna may comprise greater or fewer than four conductive elements.

The antenna may include a rigid disc-shaped printed circuit board or other rigid disc-shaped electrical connected mounted on the underside of the central region that provides an electrical connector between the feed lines and the transmission lines. The presence of the ridged disc would also help to accurately align the antenna laminate sheet onto the former and ruggedizes electrical connections from the feed lines to the transmission lines.

To prevent damage to the arms of the antenna laminate prior to assembly of the antenna, the laminate may define breakout tabs that extend between radially outward free ends of adjacent arms that can be severed when the laminate is ready to be mounted onto the former.

The principles described above may also be applied to fabricate an antenna having sinuous antenna elements that vary in halfwave length by a function other than a logarithmic function, however such antenna are unlikely to have as good broadband characteristics.

1-15. (canceled)

16. A sinuous and/or log-periodic antenna comprising:
a relatively flexible dielectric substrate carrying multiple conductive antenna elements, the dielectric substrate being mechanically supported on a relatively rigid former; wherein the dielectric substrate defines a common region and arms, and each arm being separately joined to the common region about a separate join;
wherein each arm provides a first curved surface carrying one of the multiple conductive antenna elements;
wherein the common region provides a first planar surface carrying conductive traces for connecting each conductive antenna element to a transmission line; and
wherein the dielectric substrate includes a single integral piece defining the common region and the arms, the single integral piece carrying a patterned metallic layer providing the multiple conductive antenna elements and the conductive traces.

17. A sinuous and/or log-periodic antenna according to claim 16, wherein each arm has a physical width that increases with increasing distance from its join with the common region.

18. A sinuous and/or log-periodic antenna according to claim 17, wherein each arm has a substantially constant angular width about its length.

19. A sinuous and/or log-periodic antenna according to claim 16, wherein each arm has a profile defining curves and/or features that mimic curves and/or features of the profile of the conductive element it is carrying.

20. A sinuous and/or log-periodic antenna according to claim 16, wherein the curved surface is a quadric curved surface or an ogive surface.

21. A sinuous and/or log-periodic antenna according to claim 16 in which the common region comprises:
an aperture for one or more transmission lines to extend through to electrically connect to one or more of the conductive antenna elements.

22. A sinuous and/or log-periodic antenna according to claim 16, wherein the former defines a second curved surface, and the flexible dielectric substrate lies over and conforms to the second curved surface.

23. A sinuous and/or log-periodic antenna according to claim 21, in which the former comprises:
an aperture aligned with the aperture through the common region, for the transmission line to extend through to electrically connect to one or more of the conductive antenna elements.

24. A sinuous and/or log-periodic antenna according to claim 21, wherein the former defines a second planar surface, and the flexible dielectric substrate lies over and conforms to the second planar surface.

25. A sinuous and/or log-periodic antenna according to claim 22, wherein the former defines a bridging surface interconnecting the second planar surface and the second curved surface, the bridging surface having a radius of curvature that is less than a radius of curvature of the second curved surface; and wherein the flexible dielectric substrate lies over and conforms to the bridging surface.

26. A sinuous and/or log period antenna according to claim 25, where the bridging surface has a radius of curvature that decreases between the second curved surface and the planar surface.

27. A flexible dielectric substrate configured to carry multiple conductive antenna elements of a sinuous and/or log-periodic antenna wherein the flexible dielectric substrate defines:
a common region and separate arms, each of the separate arms being joined to the common region; and each arm carrying one of the multiple conductive antenna elements.

28. A method of manufacturing an antenna laminate for a sinuous or log-periodic antenna, the method comprising:
providing a metallic layer on a dielectric substrate to form a laminate;
removing metal from the substrate to define separate conductive antenna elements; and
cutting the laminate such that the antenna laminate defines a common region and separate arms, each of the separate arms being joined to the common region; each arm carrying one of multiple conductive antenna elements for the antenna.

29. A method of manufacturing a sinuous and/or log-periodic antenna, the method comprising:
i) providing a flexible dielectric substrate carrying conductive antenna elements of the sinuous and/or log-periodic antenna, wherein the flexible dielectric substrate defines a common region and separate arms, each of the separate arms being joined to the common region, and each arm carrying one of the conductive antenna elements, and the common region carrying conductive traces for electrically connecting each conductive antenna element to a transmission line; and
ii) placing the dielectric substrate on or in a former such that the conductive antenna elements follow a curved surface provided by the former.

30. A sinuous and/or log-periodic antenna comprising:
a relatively flexible dielectric substrate carrying multiple conductive antenna elements, the dielectric substrate being mechanically supported on a relatively rigid former;
wherein the dielectric substrate defines a common region and arms, and each arm is separately joined to the common region about a separate join;
wherein each arm provides a first curved surface carrying one of the multiple conductive antenna elements; and
wherein the common region provides a first planar surface carrying conductive traces for connecting each conductive antenna element to a transmission line.
